(19) United States
(12) Patent Application Publication
(10) Pub. No.: US 2006/0009340 A1
(43) Pub. Date: Jan. 12, 2006

(54) Adjustable bias folder

(76) Inventor: William Park, Los Angeless, CA (US)

Correspondence Address: PARK & SUTTON LLP, 3255 WILSHIRE BLVD, SUITE 1110, LOS ANGELES, CA, 90010, US

(21) Appl. No.: 10/889,529

(22) Filed: Jul. 12, 2004

(51) Int. Cl. B31B 1/28

(52) U.S. Cl. 493/476

(57) ABSTRACT

An adjustable bias folder includes a fabric path through which a fabric strip passes, and an adjusting device. The fabric path includes a first end and a second end. The fabric strip enters the fabric path at the first end, and the fabric strip is folded to have one or more folded portions at the second end as the fabric strip exits the fabric path. The adjusting device adjusts the dimension of the folded portions. The adjusting device includes a first adjuster that adjusts the dimension of one of the folded portions of the fabric strip, and a second adjuster that adjusts the dimension of another one of the folded portions.

### BACKGROUND OF THE INVENTION

The present invention relates to a bias folder. More particularly, this invention relates to an adjustable bias folder that can produce various kinds of bias tapes with a single bias folder.

FIG. 5 shows a bias folder 10 by prior art. The bias folder 10 produces a bias tape of fixed type and dimension. A bias tape may be single-folded or double-folded, and folded portions of a bias tape may have different sizes depending on the use of a bias tape produced by the bias folder. A set of many number of bias folders have been required and to be replaced to produce different kinds of bias tapes.

A simpler or more efficient device for producing bias tapes has long been in need.

### SUMMARY OF THE INVENTION

The present invention contrives to solve the need that was not satisfied by the prior art.

An objective of the invention is to provide an adjustable bias folder that can produce a single-folded bias tape or a double-folded bias tape selectively without changing the bias folder.

Another objective of the invention is to provide a bias folder that can produce bias tapes having different dimensions without changing the bias folder.

To accomplish the above objectives, the present invention provides an adjustable bias folder that includes a fabric path through which a fabric strip passes and an adjusting device. The fabric path includes a first end and a second end. The fabric strip enters the fabric path at the first end. The fabric strip is folded to have one or more folded portions at the second end as the fabric strip exits the fabric path. The adjusting device adjusts the dimension of the folded portions.

The adjusting device includes a first adjuster that adjusts the dimension of one of the folded portions of the fabric strip, and a second adjuster that adjusts the dimension of another one of the folded portions of the fabric strip.

The first adjuster is movable between a first retracted position and a first extended position. The first adjuster is nearest to the second end of the fabric path in the first retracted position and farthest to the second end of the fabric path in the first extended position.

Similarly, the second adjuster is movable between a second retracted position and a second extended position. The second adjuster is nearest to the second end of the fabric path in the second retracted position and farthest to the second end of the fabric path in the second extended position.

The fabric path further includes a curved portion on which the fabric strip slides. The curved portion gradually becomes narrower from the first end to the second end.

The fabric path further includes a first recess that is positioned on one side of the curved portion and a first flange that is positioned in the first recess. The first recess and the first flange guides the fabric strip so that one of the folded portions of the fabric strip is formed. The fabric path further includes a second recess that is positioned on the other side of the curved portion and a second flange that is positioned in the second recess. The second recess and the second flange guides the fabric strip so that another one of the folded portions of the fabric strip is formed.

The first adjuster includes a first elongated plate, and a first extension. The first elongated plate includes a first plate end and a second plate end. The first extension extends from the first plate end of the first elongated plate. The first extension makes an angle with the first elongated plate. The second adjuster includes a second elongated plate, and a second extension. The second elongated plate includes a first plate end and a second plate end. The second extension extends from the second plate end of the second elongated plate. The second extension makes an angle with the second elongated plate.

The first elongated plate slides under the first recess. The first extension abuts with the second end of the fabric path when the first adjuster is in the first retracted position. The second elongated plate slides under the second recess. The second extension abuts with the second end of the fabric path when the second adjuster is in the second retracted position.

The second plate end of the first elongated plate is connected to an adjusting lever so that movement of the adjusting lever moves the first adjuster between the first retracted position and the first extended position. The second plate end of the second elongated plate is connected to the adjusting lever so that movement of the adjusting lever moves the second adjuster between the second retracted position and the second extended position.

The adjusting lever pivots with respect to a first point. The first adjuster is connected to the adjusting lever at a second point. The second adjuster is connected to the adjusting lever at a third point. The second point and the third point are oppositely positioned with respect to the first point.

The first extension is substantially perpendicular to the first elongated plate. The second extension is substantially perpendicular to the second elongated plate.

The adjustable bias folder further includes a bracket attached to the fabric path. The bracket guides the fabric strip near the second end of the fabric path.

The adjustable bias folder further includes a straightener attached to the fabric path. The straightener keeps the fabric strip in substantially the same plane with the fabric path.

An adjustable bias folder having a single adjuster that adjusts the dimension of a single folded portion of the fabric strip is also provided by the present invention.

The advantages of the present invention are: (1) a single bias folder can be used to produce a single-folded bias tape or a double-folded bias tape selectively without changing the bias folder; (2) a single bias folder can be used to produce bias tapes having folded portions of different dimensions; (3) the dimensions of the folded portions can be easily adjusted with simple operation.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a cross-sectional view showing a single folded bias tape;

FIG. 2 is a cross-sectional view showing a double folded bias tape;

FIG. 3 is a view similar to FIG. 1 but showing a folded portion having a different size;

FIG. 4 is a view similar to FIG. 2 but showing folded portions having different sizes;

FIG. 5 is an illustrative perspective view showing a bias folder by prior art;

FIG. 6 is an illustrative perspective view showing an adjustable bias folder according to the present invention;

FIG. 7 is a partial plan view of the adjustable bias folder;

FIG. 8 is a partial elevation view of the adjustable bias folder;

FIG. 9 is a partial bottom view of the adjustable bias folder;

FIG. 10 is a cross-sectional view taken along the line X-X in FIG. 7;

FIG. 11 is a cross-sectional view taken along the line XI-XI in FIG. 7;

FIG. 12 is a schematic plan view showing a first adjuster is in its extended position, and a second adjuster is in its retraced position;

FIG. 13 is a schematic plan view showing the first adjuster is in its retracted position, and the second adjuster is in its extended position; and

FIG. 14 is schematic plan view showing the first adjuster and the second adjuster are in their intermediate position.

### DETAILED DESCRIPTION OF THE INVENTION

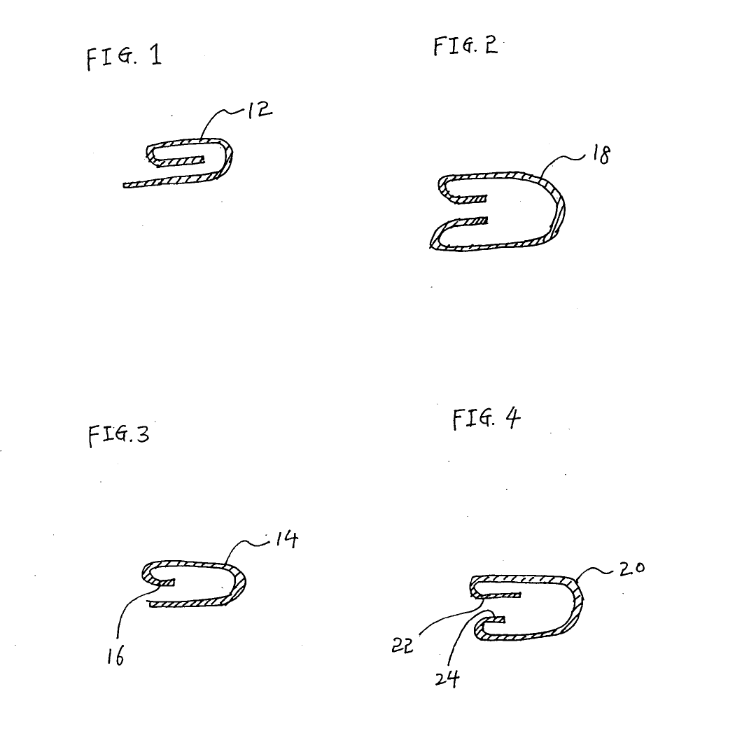

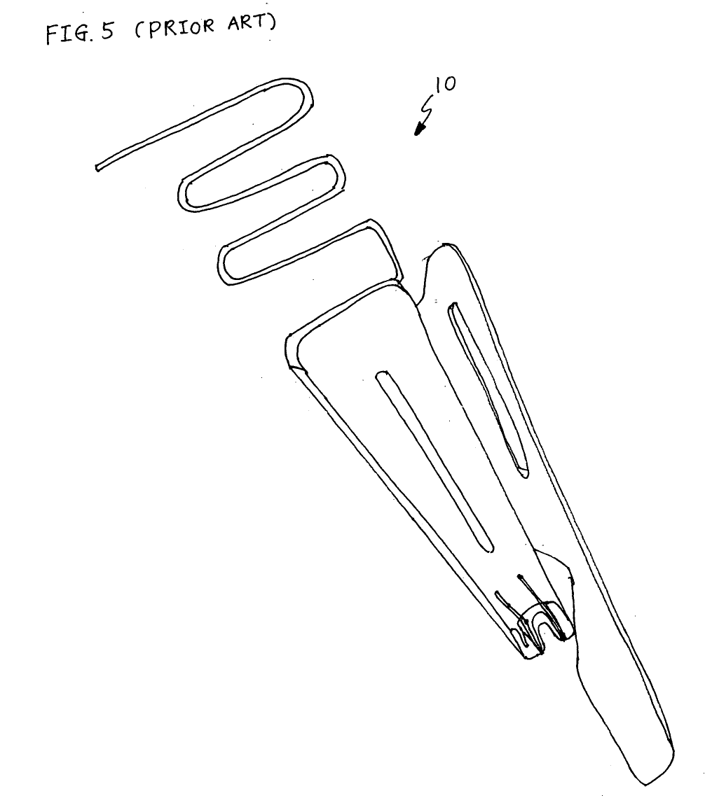

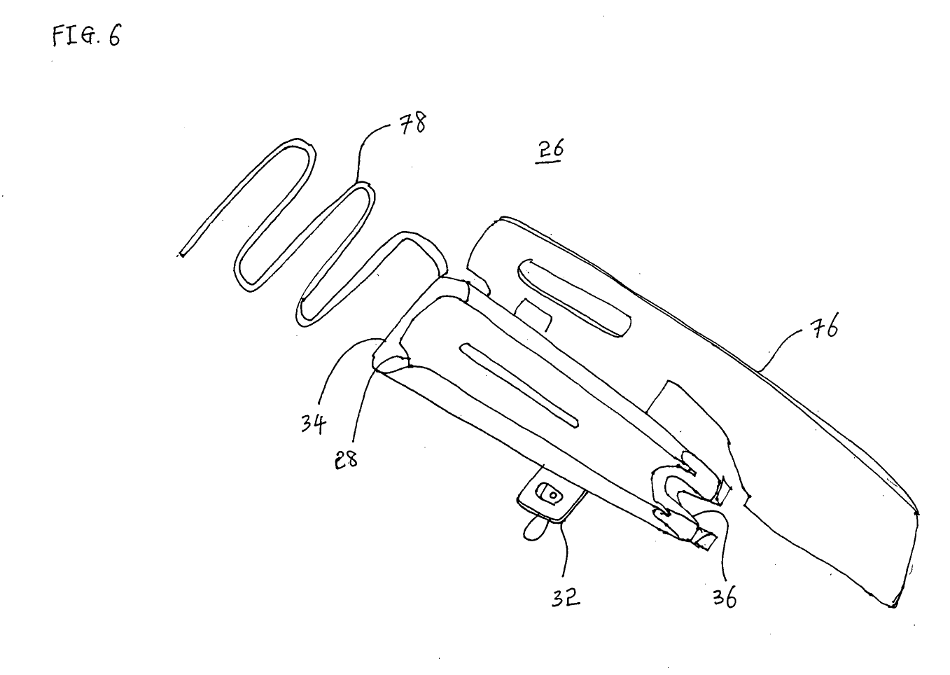

FIGS. 1-4 show various examples of bias tapes in cross-section. FIG. 1 shows a single folded bias tape 12. FIG. 3 shows another single folded bias tape 14 having a folded portion 16 of a different size. FIG. 2 shows a double folded bias tape 18. FIG. 4 shows another double folded bias tape 20 having folded portions 22, 24 having different sizes.

FIG. 6 shows an adjustable bias folder 26 according to the present invention. The adjustable bias folder 26 includes a fabric path 28 through which a fabric strip 30 passes and an adjusting device 32.

The fabric path 28 includes a first end 34 and a second end 36. The fabric strip 30 enters the fabric path 28 at the first end 34. The fabric strip 30 is folded to have one or more folded portions 16, 22 at the second end 36 as the fabric strip 30 exits the fabric path 28. The adjusting device 32 adjusts the dimension of the folded portions 16, 22.

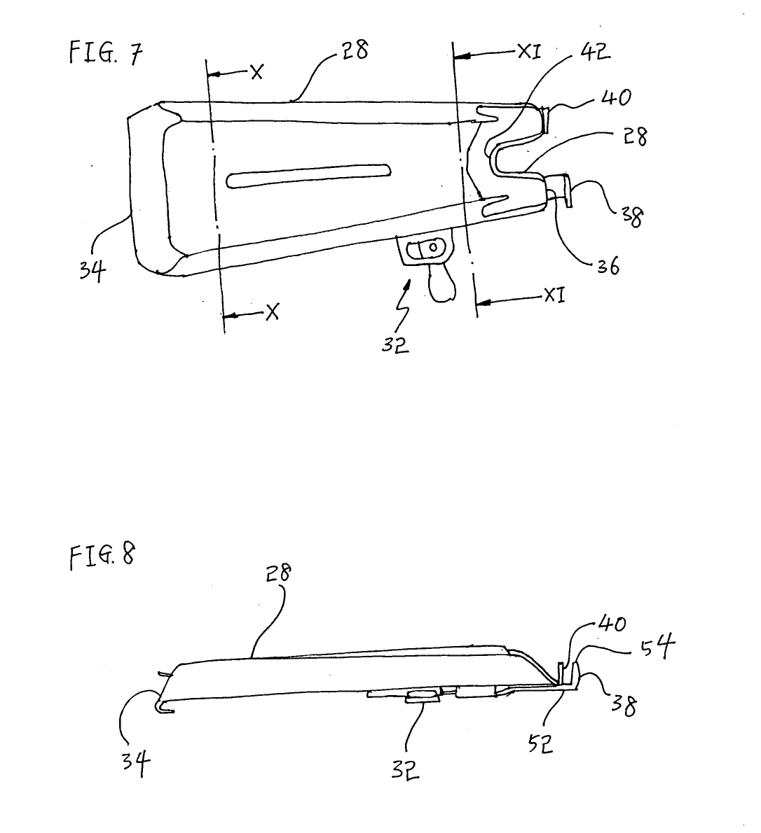

As shown in FIGS. 7-9, the adjusting device 32 includes a first adjuster 38 that adjusts the dimension of one of the folded portions 16, 22 of the fabric strip 30, and a second adjuster 40 that adjusts the dimension of another one of the folded portions of the fabric strip 30.

The first adjuster 38 is movable between a first retracted position and a first extended position. The first adjuster 38 is nearest to the second end 36 of the fabric path 28 in the first retracted position and farthest to the second end 36 of the fabric path 28 in the first extended position.

Similarly, the second adjuster 40 is movable between a second retracted position and a second extended position. The second adjuster 40 is nearest to the second end 36 of the fabric path 28 in the second retracted position and farthest to the second end 36 of the fabric path 28 in the second extended position. FIGS. 12-14 show variations of the positions of the first adjuster 38 and the second adjuster 40.

As shown in FIGS. 10 and 11, the fabric path 28 further includes a curved portion 42 on which the fabric strip 30 slides. The curved portion 42 gradually becomes narrower from the first end 34 to the second end 36.

The fabric path 28 further includes a first recess 44 that is positioned on one side of the curved portion 42 and a first flange 46 that is positioned in the first recess 44. The first recess 44 and the first flange 46 guides the fabric strip 30 so that one of the folded portions 16, 22, 24 of the fabric strip 30 is formed.

The fabric path 28 further includes a second recess 48 that is positioned on the other side of the curved portion 42 and a second flange 50 that is positioned in the second recess 48. The second recess 48 and the second flange 50 guides the fabric strip 30 so that another one of the folded portions 16, 22, 24 of the fabric strip 30 is formed.

The first adjuster 38 includes a first elongated plate 52, and a first extension 54. The first elongated plate 52 includes a first plate end 56 and a second plate end 58. The first extension 54 extends from the first plate end 56 of the first elongated plate 52. The first extension 54 makes an angle with the first elongated plate 52.

The second adjuster 40 includes a second elongated plate 60, and a second extension 62. The second elongated plate 60 includes a first plate end 64 and a second plate end 66. The second extension 62 extends from the second plate end 66 of the second elongated plate 60. The second extension 62 makes an angle with the second elongated plate 60.

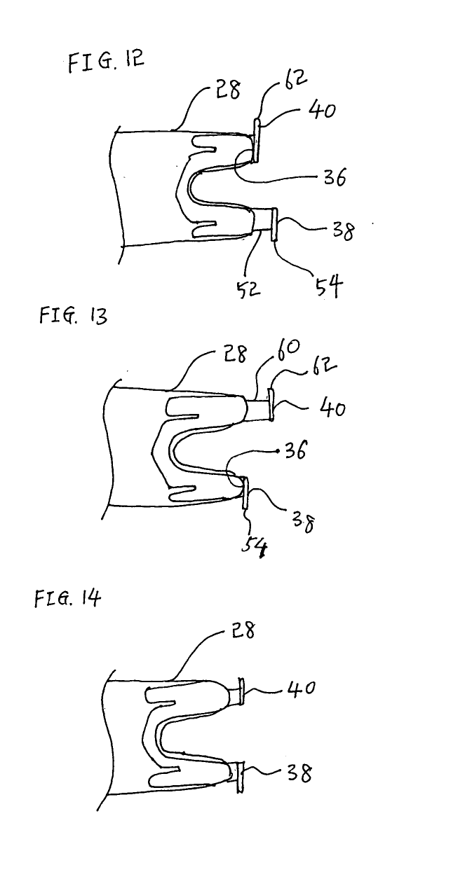

The first elongated plate 52 slides under the first recess 44. The first extension 54 abuts with the second end 36 of the fabric path 28 when the first adjuster 38 is in the first retracted position as shown in FIG. 13.

The second elongated plate 60 slides under the second recess 48. The second extension 62 abuts with the second end 36 of the fabric path 28 when the second adjuster 40 is in the second retracted position as shown in FIG. 12.

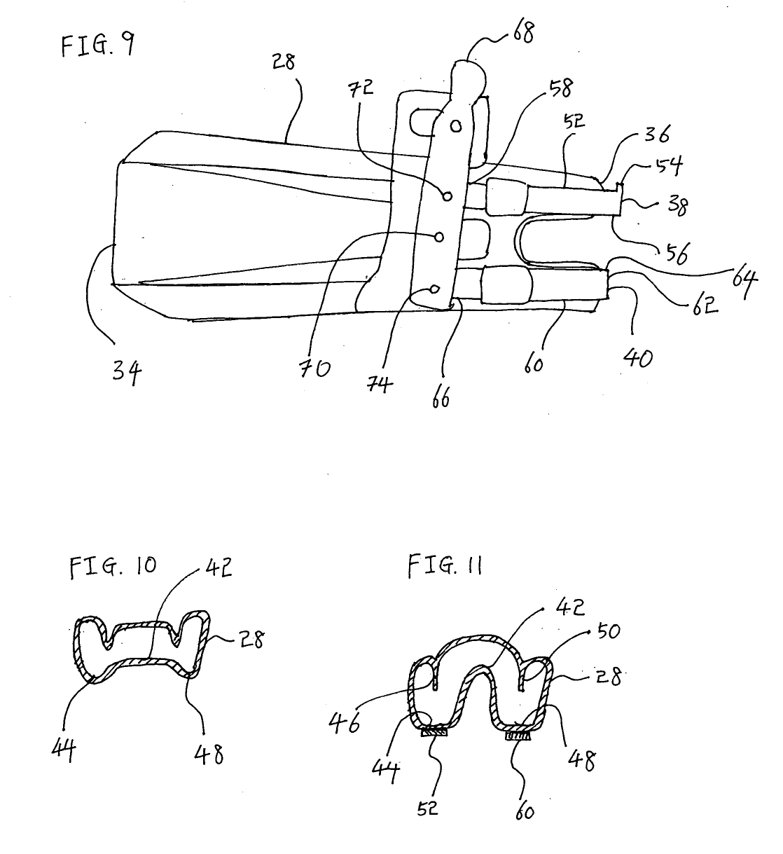

Referring back to FIG. 9, the second plate end 58 of the first elongated plate 52 is connected to an adjusting lever 68 so that movement of the adjusting lever 68 moves the first adjuster 38 between the first retracted position and the first extended position.

The second plate end 66 of the second elongated plate 60 is connected to the adjusting lever 68 so that movement of the adjusting lever 68 moves the second adjuster 40 between the second retracted position and the second extended position.

The adjusting lever 68 is pivotally attached to the fabric path 28. The adjusting lever 68 pivots with respect to a first point 70. The first adjuster 38 is connected to the adjusting lever 68 at a second point 72. The second adjuster 40 is connected to the adjusting lever 68 at a third point 74. The second point 72 and the third point 74 are oppositely positioned with respect to the first point 70 so that the first adjuster 38 and the second adjuster 40 are moved oppositely with each other by pivoting the adjusting lever 68.

The first extension 54 is substantially perpendicular to the first elongated plate 52. The second extension 62 is substantially perpendicular to the second elongated plate 60.

Referring back to FIG. 6, the adjustable bias folder 26 further includes a bracket 76 attached to the fabric path 28. The bracket 76 guides the fabric strip 30 near the second end 36 of the fabric path 28.

The adjustable bias folder 26 further includes a straightener 78 attached to the fabric path 28. The straightener 78 keeps the fabric strip 30 in substantially the same plane with the fabric path 28.

An adjustable bias folder having a single adjuster that adjusts the dimension of a single folded portion of the fabric strip is also possible.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An adjustable bias folder that folds a fabric strip comprising:
a) a fabric path through which the fabric strip passes, wherein the fabric path comprises a first end and a second end, wherein the fabric strip enters the fabric path at the first end, wherein the fabric strip is folded to have one or more folded portions at the second end as the fabric strip exits the fabric path; and
b) an adjusting device that adjusts the dimension of the folded portions.

2. The adjustable bias folder of claim 1, wherein the adjusting device comprises a first adjuster that adjusts the dimension of one of the folded portions of the fabric strip.

3. The adjustable bias folder of claim 2, wherein the first adjuster is movable between a first retracted position and a first extended position, wherein the first adjuster is nearest to the second end of the fabric path in the first retracted position and farthest to the second end of the fabric path in the first extended position.

4. The adjustable bias folder of claim 3, wherein the fabric path further comprises a curved portion on which the fabric strip slides, wherein the curved portion gradually becomes narrower from the first end to the second end.

5. The adjustable bias folder of claim 4, wherein the fabric path further comprises a first recess that is positioned on one side of the curved portion and a first flange that is positioned in the first recess, wherein the first recess and the first flange guides the fabric strip so that one of the folded portions of the fabric strip is formed.

6. The adjustable bias folder of claim 3, wherein the first adjuster comprises a first elongated plate, and a first extension, wherein the first elongated plate comprises a first plate end and a second plate end, wherein the first extension extends from the first plate end of the first elongated plate, wherein the first extension makes an angle with the first elongated plate.

7. The adjustable bias folder of claim 6, wherein the first elongated plate slides under the first recess, wherein the first extension abuts with the second end of the fabric path when the first adjuster is in the first retracted position.

8. The adjustable bias folder of claim 7, wherein the second plate end of the first elongated plate is connected to an adjusting lever so that movement of the adjusting lever moves the first adjuster between the first retracted position and the first extended position.

9. The adjustable bias folder of claim 6, wherein the first extension is substantially perpendicular to the first elongated plate.

10. The adjustable bias folder of claim 2, wherein the adjusting device further comprises a second adjuster that adjusts the dimension of another one of the folded portions of the fabric strip.

11. The adjustable bias folder of claim 10, wherein the first adjuster is movable between a first retracted position and a first extended position, wherein the first adjuster is nearest to the second end of the fabric path in the first retracted position and farthest to the second end of the fabric path in the first extended position, wherein the second adjuster is movable between a second retracted position and a second extended position, wherein the second adjuster is nearest to the second end of the fabric path in the second retracted position and farthest to the second end of the fabric path in the second extended position.

12. The adjustable bias folder of claim 11, wherein the fabric path further comprises a curved portion on which the fabric strip slides, wherein the curved portion gradually becomes narrower from the first end to the second end.

13. The adjustable bias folder of claim 12, wherein the fabric path further comprises a first recess that is positioned on one side of the curved portion and a first flange that is positioned in the first recess, wherein the first recess and the first flange guides the fabric strip so that one of the folded portions of the fabric strip is formed, wherein the fabric path further comprises a second recess that is positioned on the other side of the curved portion and a second flange that is positioned in the second recess, wherein the second recess and the second flange guides the fabric strip so that another one of the folded portions of the fabric strip is formed.

14. The adjustable bias folder of claim 11, wherein the first adjuster comprises a first elongated plate, and a first extension, wherein the first elongated plate comprises a first plate end and a second plate end, wherein the first extension extends from the first plate end of the first elongated plate, wherein the first extension makes an angle with the first elongated plate, wherein the second adjuster comprises a second elongated plate, and a second extension, wherein the second elongated plate comprises a first plate end and a second plate end, wherein the second extension extends from the second plate end of the second elongated plate, wherein the second extension makes an angle with the second elongated plate.

15. The adjustable bias folder of claim 14, wherein the first elongated plate slides under the first recess, wherein the first extension abuts with the second end of the fabric path when the first adjuster is in the first retracted position, wherein the second elongated plate slides under the second recess, wherein the second extension abuts with the second end of the fabric path when the second adjuster is in the second retracted position.

16. The adjustable bias folder of claim 15, wherein the second plate end of the first elongated plate is connected to an adjusting lever so that movement of the adjusting lever moves the first adjuster between the first retracted position and the first extended position, wherein the second plate end of the second elongated plate is connected to the adjusting lever so that movement of the adjusting lever moves the second adjuster between the second retracted position and the second extended position.

17. The adjustable bias folder of claim 16, wherein the adjusting lever pivots with respect to a first point, wherein the first adjuster is connected to the adjusting lever at a second point, wherein the second adjuster is connected to the adjusting lever at a third point, wherein the second point and the third point are oppositely positioned with respect to the first point.

18. The adjustable bias folder of claim 14, wherein the first extension is substantially perpendicular to the first elongated plate, wherein the second extension is substantially perpendicular to the second elongated plate.

19. The adjustable bias folder of claim 1, further comprising a bracket attached to the fabric path, wherein the bracket guides the fabric strip near the second end of the fabric path.

20. The adjustable bias folder of claim 1, further comprising a straightener attached to the fabric path, wherein the straightener keeps the fabric strip in substantially the same plane with the fabric path.
